(19) United States
(12) Patent Application Publication
(10) Pub. No.: US 2008/0065438 A1
(43) Pub. Date: Mar. 13, 2008

(54) SYSTEM AND METHOD FOR PROCESSING A WORKFLOW FORM

(75) Inventors: CHUNG-I LEE, Tu-Cheng (TW); CHIEN-FA YEH, Tu-Cheng (TW); CHIU-HUA LU, Tu-Cheng (TW); XIAO-DI FAN, Shenzhen (CN); XIAO-PING ZHANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/759,241

(22) Filed: Jun. 7, 2007

(30) Foreign Application Priority Data
Sep. 13, 2006 (CN) 200610200869.6

(51) Int. Cl. G06F 17/50

(52) U.S. Cl. 705/7

(57) ABSTRACT

An exemplary method for processing a workflow form is provided. The method includes: connecting a workflow engine and an business sub-system; receiving a data form processing request from a client; obtaining workflow information from the workflow engine according to the data form processing request; obtaining business information from the business sub-system according to the data form processing request; establishing a worklist for storing items according to the workflow information, business information, and personal data of the client; selecting an appropriate data form and generating a workflow form by storing an open item in the data form; and processing the workflow form by signing the workflow form or rejecting the workflow form. A related system is also provided.

### BACKGROUND OF THE INVENTION

1. Field of the Invention

The present invention relates to a system and method for processing a workflow form.

2. Description of Related Art

As “web” technology has evolved, data forms continue to be an important part of the Web sites, Web applications and electronic commerce solutions have sparked the demands for better Web forms with richer interactions. To address this concern, the worldwide web consortium (W3C) has introduced a new three-part standard of Web forms, referred to as XForms that is in the extensible markup language (XML) format. XForms allows the creation of a new platform-independent markup language for online interaction between an XForms processor and a remote entity. XForms is a successor to XHTML forms, and benefit from the lessons learned in the years of XHTML forms implementation experience. A primary objective of XForms is to separate data from the presentation of the data to a user, in order to overcome the aforementioned shortcomings of XHTML forms.

XForms provides a richer and presentation independent way of handling interactive Web transactions. By splitting traditional XHTML forms into three parts-data model, instance data, and user interface (presentation)-XForms overcomes the aforestated limitations of XHTML forms by separating the data and logicality of a form from its presentation. In this manner, the data forms can be defined independent of how the end-user will interact with the application. In some complicated data forms, one part of the data forms is related to a business system (i.e., a processor setting of the data forms), and the other part is related to a workflow engine. The workflow engine controls processing of workflow required to approve the requested data forms. Data processing, and integration of the business system and workflow engine are difficult to be solved.

What is needed, therefore, is a system and method for processing a workflow form, which can connect the workflow engine with the business system, and sustain series forms and workflows.

### SUMMARY OF THE INVENTION

A system for processing a workflow form is disclosed. The system includes a worklist database and a worklist sub-system. The worklist database is configured for storing form configuration information and system management configuration information that are related to processing a workflow form. The worklist sub-system is configured for connecting a workflow engine and a business sub-system. The worklist sub-system includes a connecting unit, a worklist storing unit, and a form processing unit. The connecting unit is configured for connecting the workflow engine and the business sub-system by utilizing a data link. The worklist storing unit is configured for receiving a data form processing request from a client, and for obtaining workflow information and business information from the workflow engine and the business sub-system according to the data form processing request. The worklist storing unit is configured for obtaining personal data of the client from the system management configuration information, and for establishing a worklist for storing items according to the workflow information, the business information, and the personal data. The form processing unit is configured for selecting an appropriate data form from the form configuration information, generating a workflow form by storing an open item of the worklist in the data form, and for processing the workflow form.

A method for processing a workflow form is disclosed. The method includes: connecting a workflow engine and a business sub-system by utilizing a data link; receiving a data form processing request from a client; obtaining workflow information from the workflow engine according to the data form processing request; obtaining business information from the business sub-system according to the data form processing request; establishing a worklist for storing items according to the workflow information, business information, and personal data of the client; selecting an appropriate data form and generating a workflow form by storing an open item in the data form; and processing the workflow form by signing the workflow form or rejecting the workflow form.

Other systems, methods, features, and advantages of the present invention will be or become apparent to one with skill in the art upon examination of the following drawings and detailed description.

### BRIEF DESCRIPTION OF THE DRAWINGS

FIG. 1 is a schematic diagram illustrating an application environment of a system for processing a workflow form in accordance with one embodiment;

FIG. 2 is a schematic diagram of function units of the worklist sub-system of FIG. 1;

FIG. 3 is a worklist of items;

FIG. 4 is a workflow form of one item of FIG. 3; and

FIG. 5 is a flowchart of a preferred method for processing a workflow form in accordance with another embodiment.

### DETAILED DESCRIPTION OF THE INVENTION

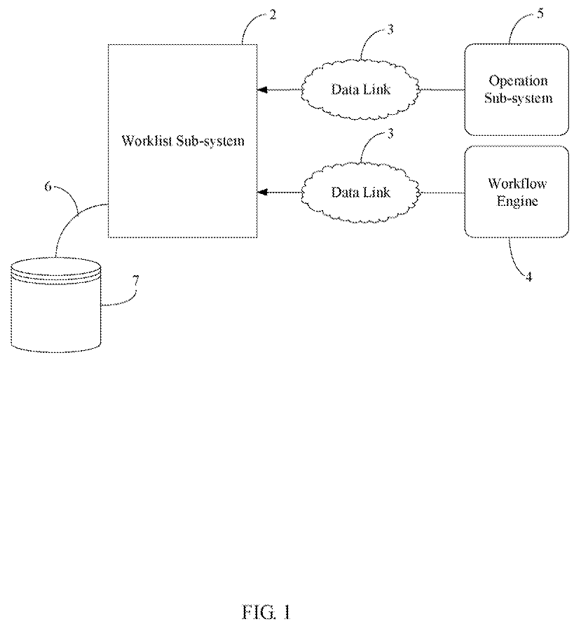

FIG. 1 is a schematic diagram illustrating an application environment of a system for processing a workflow form (hereinafter, “the system”), in accordance with one preferred embodiment. The system is implemented in a computer (i.e. an application server, or a client computer). Client computers share information through a network. Complicated data forms allow checking account balances, purchasing airline tickets, and/or checking email accounts from the client computers through the network. In the preferred embodiment, the computer typically includes a worklist sub-system 2, a workflow engine 4, at least one business sub-system 5, and a worklist database 7 connected with the worklist sub-system 2 via a connection 6. The worklist sub-system 2 connects with the workflow engine 4 and the at least one business sub-system 5 via a data link 3. The data link 3 includes WebService or EJB.

In the preferred embodiment, the system creates electronic data forms by utilizing Xforms, the electronic data forms are formatted in the extensible markup language (XML) format or Java format, and outputs various types of electronic data forms. The XForms provide a superior way to build web-based forms that are more versatile, and device independent.

The worklist sub-system 2 connects to the workflow engine 4 and the business sub-system 5 by utilizing the data link 3 (i.e., WebService or EJB), so that the workflow engine 4 can exchange data with the business sub-system 5. If the worklist sub-system 2 connects to the workflow engine 4 and the business sub-system 5 by utilizing the WebService, data of the workflow engine 4 exchanges with the data of the business sub-system 5 in the XML format. For example, a request sent by the workflow engine 4 sends a request to the business sub-system 5 in the XML format, and then the business sub-system 5 sends a feedback result to the workflow engine 4 in the XML format. Otherwise, if the worklist sub-system 2 connects to the workflow engine 4 and the business sub-system 5 by utilizing the EJB, the data of the workflow engine 4 exchanges with the data of the business sub-system 5 in the Java format. When a data form processing request is sent to the system, the system obtains a workflow form by connecting to the workflow engine 4 and the business sub-system 5, and then processes the workflow form.

The worklist database 7 is configured for storing a plurality of configuration information related to the workflow form processing. The configuration information include workflow configuration information (i.e., related information of the business sub-system 5 and the workflow engine 4), data form configuration information (i.e., data forms to be selected), and system management configuration information (i.e., personal data of clients and group management information).

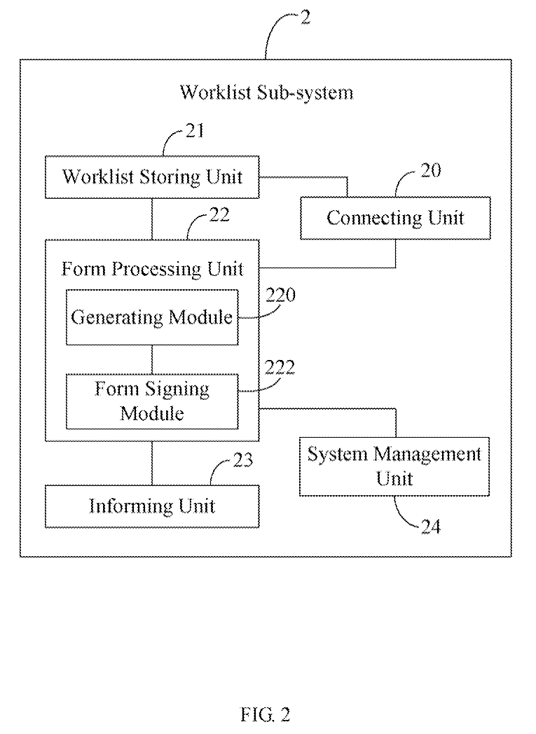

FIG. 2 is a schematic diagram of function units of the worklist sub-system 2 of FIG. 1. The worklist sub-system 2 mainly includes a connecting unit 20, a worklist storing unit 21, a form processing unit 22, an informing unit 23, and a system management unit 24.

The connecting unit 20 is configured for connecting the worklist sub-system 2 to the workflow engine 4 and the business sub-system 5 by utilizing the data link 3, in order that the workflow engine 4 can exchange data with the business sub-system 5.

The worklist storing unit 21 is configured for receiving the data form processing request from the client who is considered as an applicant applying for processing the data form, for obtaining corresponding workflow information and business information from the workflow engine 4 and the business sub-system 5 that are connected. The worklist storing unit 21 is configured for obtaining the personal data from the system management configuration information stored in the worklist database 7, and for generating a worklist for storing items to be processed. The worklist includes at least one item. The workflow information includes the request on processing data forms. In the preferred embodiment, the business information typically includes “number/subject/applicant/editor/date/state/undertake/name/display”. Alternatively, the worklist storing unit 21 can obtain the personal data from the system management unit 24 via the form processing unit 22.

The form processing unit 22 is configured for generating a workflow form by storing an open item in an appropriate data form, and processing the workflow form. The form processing unit 22 includes a generating module 220 and a form signing module 222.

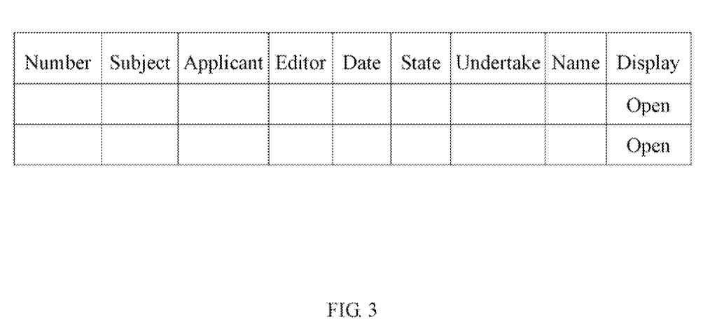

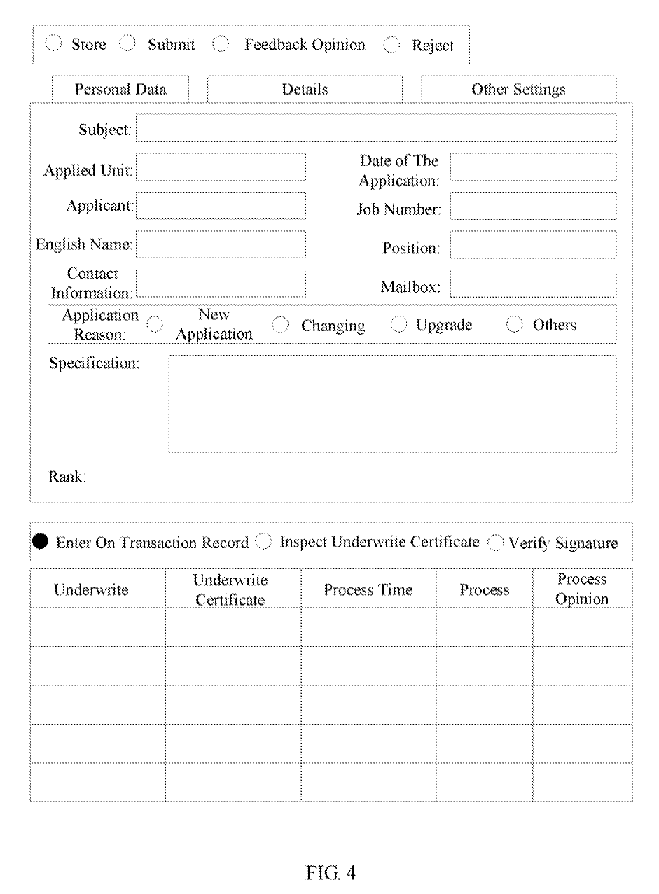

Referring to FIG. 3 and FIG. 4, FIG. 3 is a worklist of items, and FIG. 4 is a workflow form of one item of FIG. 3. When one item of the worklist is opened (see FIG. 3, the item tag of the worklist is an “open” tag), the generating module 220 selects an appropriate data form from the data form configuration information, and generates the workflow form by storing the item in the data form (see FIG. 4). The form signing module 222 processes the workflow form, for example, signing the workflow form, rejecting the workflow form, or describing the workflow form with a remark. The remark may include a signing result representing the step of approving the workflow form, or a rejection remark representing the step of rejecting the workflow form. For example, if there is a format error in the workflow form to be signed, the form signing module 222 rejects the workflow form with the rejection remark that the workflow form has a format error; if the data of the workflow form is error, the form signing module 222 rejects the workflow form with the rejection remark that the data of the workflow form is error.

In the preferred embodiment, the workflow form is configured with a certificate authority (CA). The CA is an authority in the network that issues and manages security credentials and public key for message encryption. As part of a public key infrastructure (PKI), the CA checks with a registration authority (RA) to verify information provided by the requestor of a digital certificate. If the RA verifies the requestor's information, the CA can issue a certificate. Depending on the PKI implementation, the certificate includes the client's public key, the expiration date of the certificate, the client's name, and other information about the client.

The informing unit 23 is configured for sending a processing result (i.e., a signing result or a rejection remark) of the workflow form to the client when the form signing module 222 finishes processing the workflow form.

The system management unit 24 can be configured in the workflow engine 4, the worklist sub-system 2 or the business sub-system 5. The system management unit 24 is configured for managing the personal data and the group information. For example, the client needs to login the system before the client sends the data form processing request to the system, the system management unit 24 obtains the personal data from the system management configuration information, then determines whether the client has an authorization to access the system.

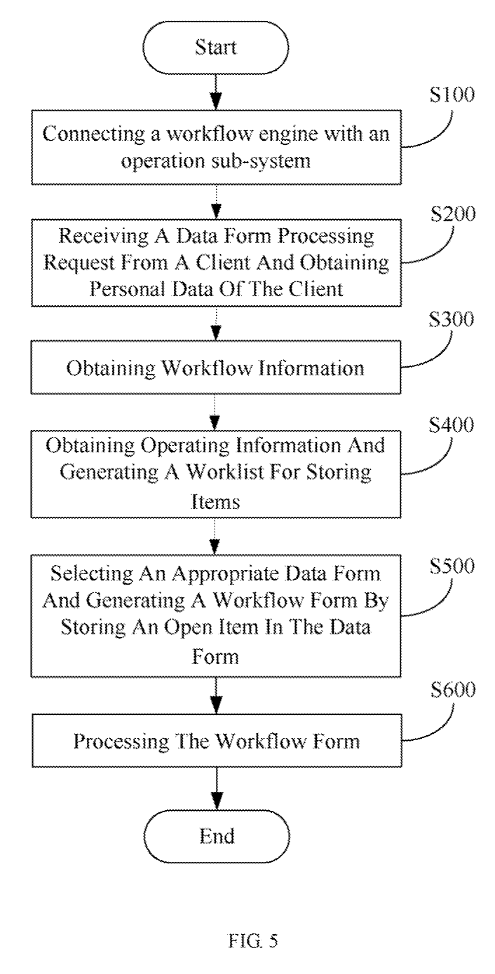

FIG. 5 is a flowchart of a preferred method for processing a workflow form in accordance with the preferred embodiment. In step S100, the connecting unit 20 connects the worklist sub-system 2 to the workflow engine 4 and the business sub-system 5 via the data link 3 such as WebService or EJB.

In step S200, the worklist storing unit 21 receives the data form processing request from the client, and obtains the personal data from the system management configuration information. The personal data includes a name of the applicant (the client), a subject, an applied unit, contact information, mailbox, and so on.

In step S300, the worklist storing unit 21 obtains the workflow information from the workflow engine 4 according to the data form processing request.

In step S400, the worklist storing unit 21 obtains the business information from the business sub-system 5 according to the data form processing request, and generates the worklist for storing the items to be processed. The business information may include “number/subject/applicant/editor/date/state/undertake/name/display”.

In step S500, when a tag of one item is an “opened” tag in the worklist, the generating module 220 selects an appropriate data form, and generates a workflow form by storing the item in the appropriate data form.

In step S600, the form signing module 222 processes the workflow form by utilizing the form processing steps that may include the step of approving the workflow form with the singing result, or the step of rejecting the workflow for with the rejection remark.

If the form signing module 222 approves the workflow form, the worklist sub-system 2 updates the business sub-system 5, and then the informing unit 23 sends the signing result of the workflow form to the client. On contrary, if the form signing module 222 rejects the workflow form, the informing unit 23 sends the rejection remark of the workflow form to the client.

It should be emphasized that the above-described embodiments of the present invention, particularly, any “preferred” embodiments, are merely possible examples of implementations, set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure, and the present invention is protected by the following claims.

What is claimed is:

1. A system for processing a workflow form, the system comprising:
a worklist database configured for storing form configuration information and system management configuration information that are related to processing a workflow form; and
a worklist sub-system configured for connecting a workflow engine and a business sub-system, the worklist sub-system comprising:
a connecting unit configured for connecting worklist sub-system to the workflow engine and the business sub-system by utilizing a data link;
a worklist storing unit configured for receiving a data form processing request from a client, the worklist storing unit configured for obtaining workflow information and business information from the workflow engine and the business sub-system according to the data form processing request, the worklist storing unit configured for obtaining personal data of the client from the system management configuration information, and the worklist storing unit configured for creating a worklist for storing items according to the workflow information, the business information, and the personal data; and
a form processing unit configured for selecting an appropriate data form from the form configuration information, generating a workflow form by storing an open item of the worklist in the data form, and for processing the workflow form.

2. The system according to claim 1, wherein the data link is WebService.

3. The system according to claim 1, wherein the data link is enterprise java bean (EJB).

4. The system according to claim 1, wherein the workflow form is configured with a certificate authority (CA).

5. The system according to claim 1, wherein the worklist sub-system further comprises an informing unit configured for informing a processing result of the workflow form to the client.

6. The system according to claim 5, wherein the processing result comprises a signing result of the workflow form and a rejection remark of the workflow form.

7. The system according to claim 1, where the worklist sub-system further comprises a system management unit configured for managing the personal data of the client and group information when the client sends the data form processing request.

8. The system according to claim 1, wherein the workflow form is created by utilizing the standard of Xforms, and formatted with a language of an extensible markup language (XML) format.

9. The system according to claim 8, wherein the data of the workflow engine exchanges with the data of the business sub-system based on the XML format, if the worklist sub-system connects the workflow engine and the business sub-system by utilizing the data link of WebService.

10. The system according to claim 1, wherein the workflow form is created by utilizing the standard of Xforms, and formatted with a language of aJava format

11. The system according to claim 10, wherein the data of the workflow engine exchanges with the data of the business sub-system based on the Java format, if the worklist sub-system connects the workflow engine and the business sub-system by utilizing the data link of EJB.

12. A computerized method for processing a workflow form, the method comprising:
connecting a workflow engine and a business sub-system by utilizing a data link. receiving a data form processing request from a client;
obtaining workflow information from the workflow engine according to the data form processing request;
obtaining business information from the business sub-system according to the data form processing request;
establishing a worklist for storing items according to the workflow information, business information, and personal data of the client;
selecting an appropriate data form and generating a workflow form by storing an open item in the data form; and
processing the workflow form by signing the workflow form or rejecting the workflow form.

13. The system according to claim 12, wherein the data link is a WebService.

14. The system according to claim 13, wherein the data of the workflow engine exchanges with the data of the business sub-system based on an extensible markup language format, if the worklist sub-system connects the workflow engine and the business sub-system by utilizing the data link of WebService.

15. The system according to claim 12, wherein the data link is an enterprise Java bean.

16. The system according to claim 15, wherein the data of the workflow engine exchanges with the data of the business sub-system based on a Java format, if the worklist sub-system connects the workflow engine and the business sub-system by utilizing the data link of EJB.

17. The system according to claim 12, wherein the workflow form is configured with a certificate authority (CA).

18. The method according to claim 12, wherein the step of processing the workflow form comprises a step of signing the workflow form with a signing result, and a step of rejecting the workflow form with a rejection remark.

19. The method according to claim 18, further comprising:
sending the signing result of the workflow form to the client if the workflow form is signed; and
sending the rejection remark of the workflow form to the client if the workflow form is rejected.
